(19) United States
(12) Patent Application Publication
(10) Pub. No.: US 2018/0011438 A1
(43) Pub. Date: Jan. 11, 2018

(54) POST PROCESSING APPARATUS AND IMAGE FORMING SYSTEM

(71) Applicant: FUJI XEROX CO., LTD., Tokyo (JP)

(72) Inventors: Akira SAKUMA, Kanagawa (JP); Shinji MASAKI, Kanagawa (JP); Kenji SUZUKI, Kanagawa (JP); Katsushi AMARUME, Kanagawa (JP); Daisuke ISHIKAWA, Nagano (JP)

(73) Assignee: FUJI XEROX CO., LTD., Tokyo (JP)

(21) Appl. No.: 15/589,343

(22) Filed: May 8, 2017

(30) Foreign Application Priority Data
Jul. 5, 2016 (JP) 2016-133186

(51) Int. Cl. G03G 15/00

(52) U.S. Cl. CPC G03G 15/6529; G03G 15/6582

(57) ABSTRACT

A post-processing apparatus includes a side edge part removing portion that removes a side edge part from a sheet; a side edge part housing section that houses the side edge part removed by the side edge part removing portion and that is able to be pulled out from an apparatus body; and a guide plate that is inclined in a direction intersecting with a moving direction of the side edge part and guides the side edge part removed by the side edge part removing portion along the moving direction of the side edge part to the side edge part housing section.

### CROSS-REFERENCE TO RELATED APPLICATIONS

This application is based on and claims priority under 35 USC 119 from Japanese Patent Application No. 2016-133186 filed Jul. 5, 2016.

### BACKGROUND

### Technical Field

The present invention relates to a post-processing apparatus and an image forming system.

### SUMMARY

According to an aspect of the invention, there is provided a post-processing apparatus including a side edge part removing portion that removes a side edge part from a sheet; a side edge part housing section that houses the side edge part removed by the side edge part removing portion and that is able to be pulled out from an apparatus body; and a guide plate that is inclined in a direction intersecting with a moving direction of the side edge part and guides the side edge part removed by the side edge part removing portion along the moving direction of the side edge part to the side edge part housing section.

Exemplary embodiments of the present invention will be described in detail based on the following figures, wherein:

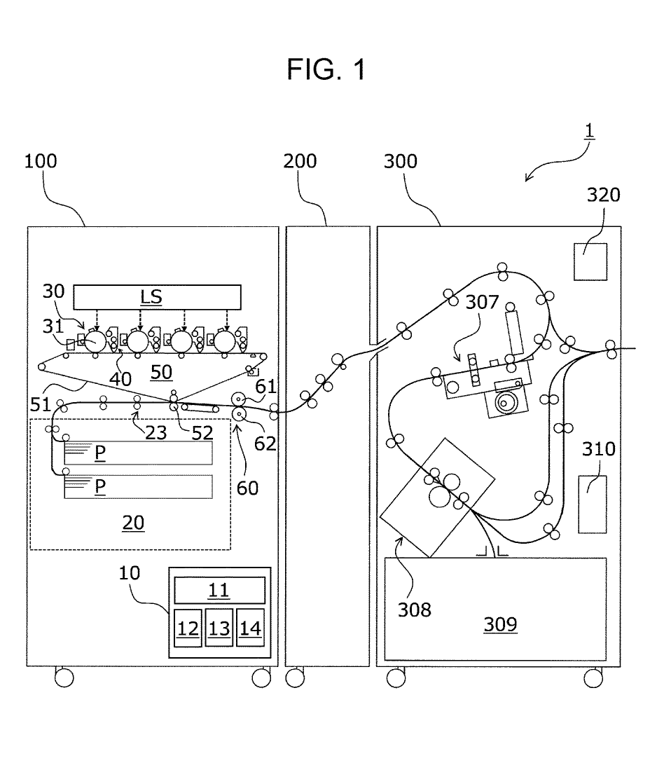

FIG. 1 is a schematic sectional view showing an inside configuration of an image forming system;

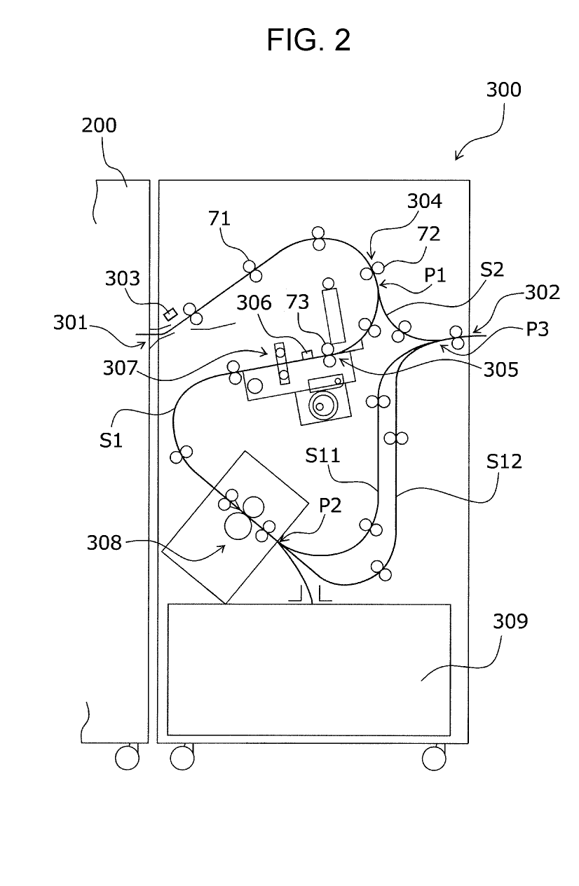

FIG. 2 is a schematic sectional view of a post-processing apparatus according to a first exemplary embodiment;

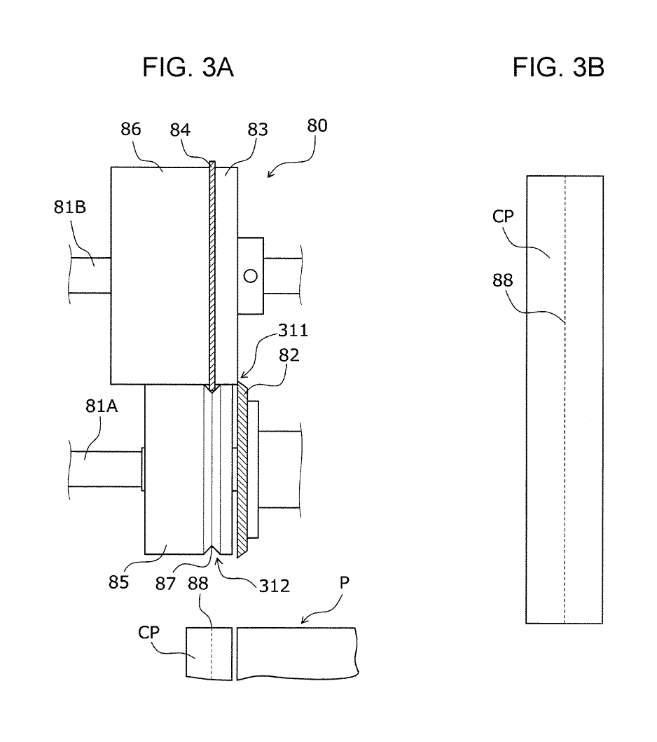

FIG. 3A illustrates a structure of a cutter unit included in a side edge part removing section, and FIG. 3B illustrates a side edge part of a sheet;

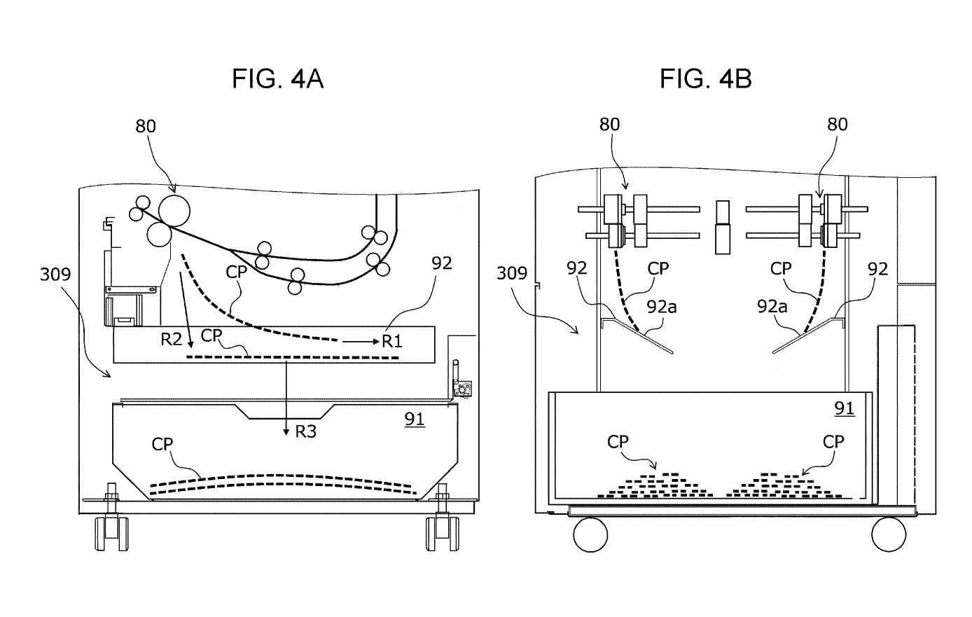

FIG. 4A is a schematic longitudinal section of a sheet-waste housing section, and FIG. 4B is a schematic cross section of the sheet-waste housing section;

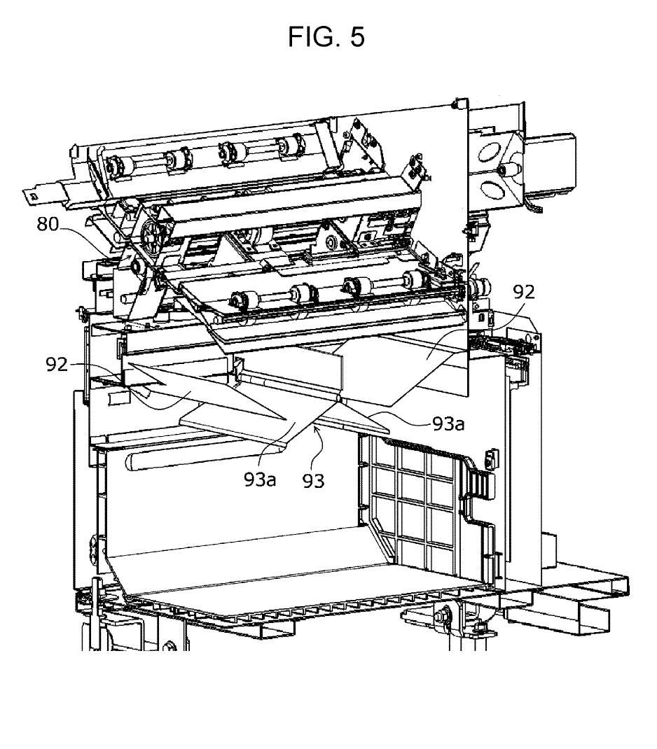

FIG. 5 is a perspective sectional view of a sheet-waste housing section according to a first modification;

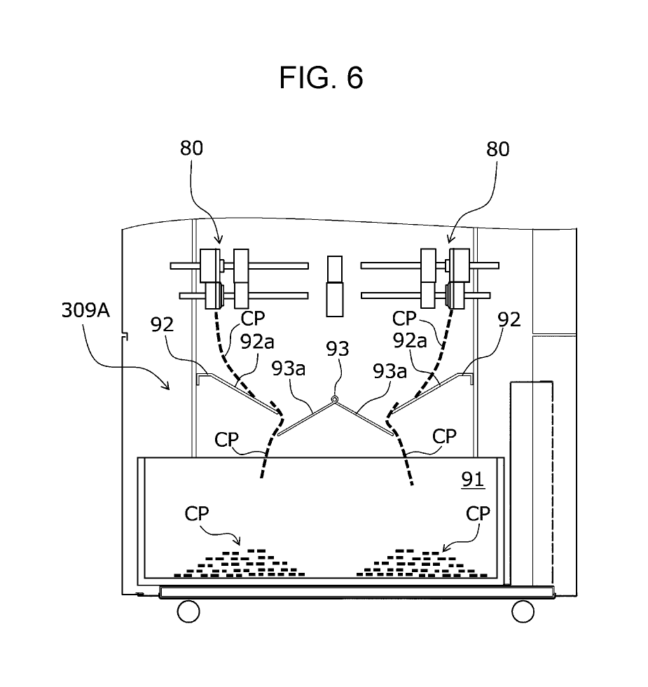

FIG. 6 is a schematic cross section of the sheet-waste housing section according to the first modification;

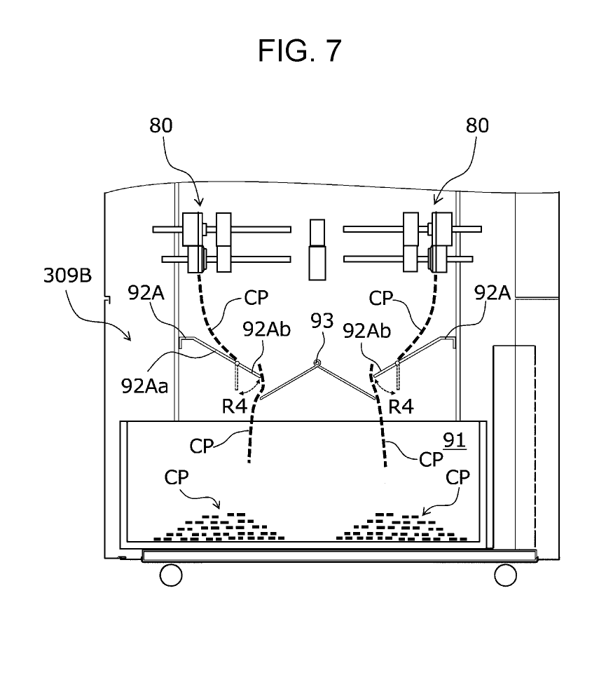

FIG. 7 is a schematic cross section of a sheet-waste housing section according to a second modification;

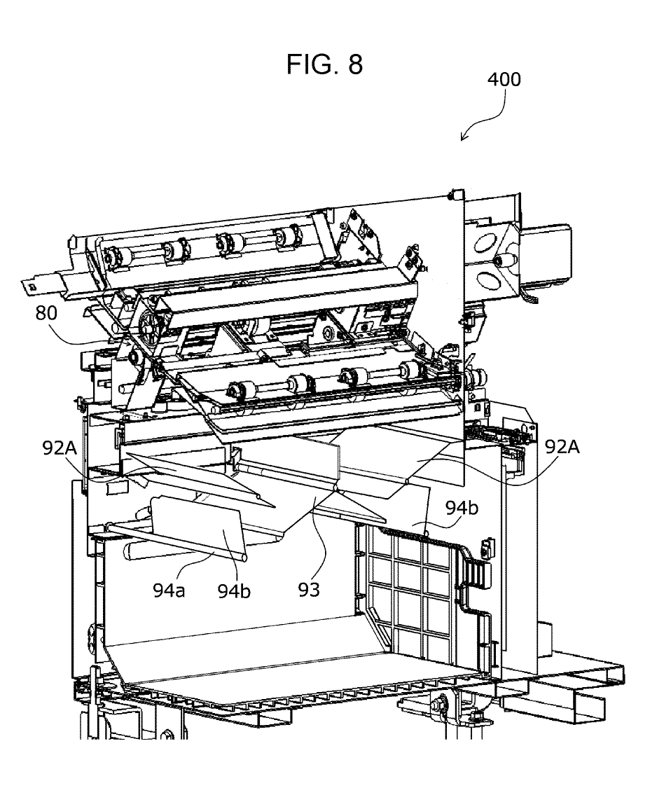

FIG. 8 is a perspective sectional view showing a sheet-waste housing section of a post-processing apparatus according to a second exemplary embodiment;

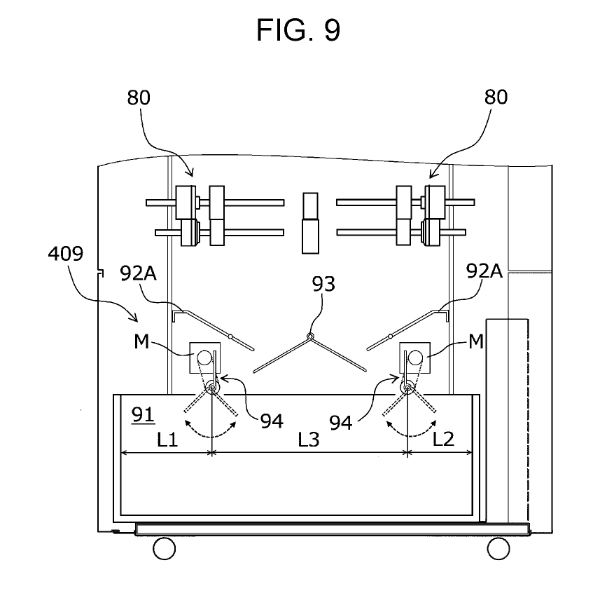

FIG. 9 is a schematic cross section of the sheet-waste housing section of the post-processing apparatus according to the second exemplary embodiment;

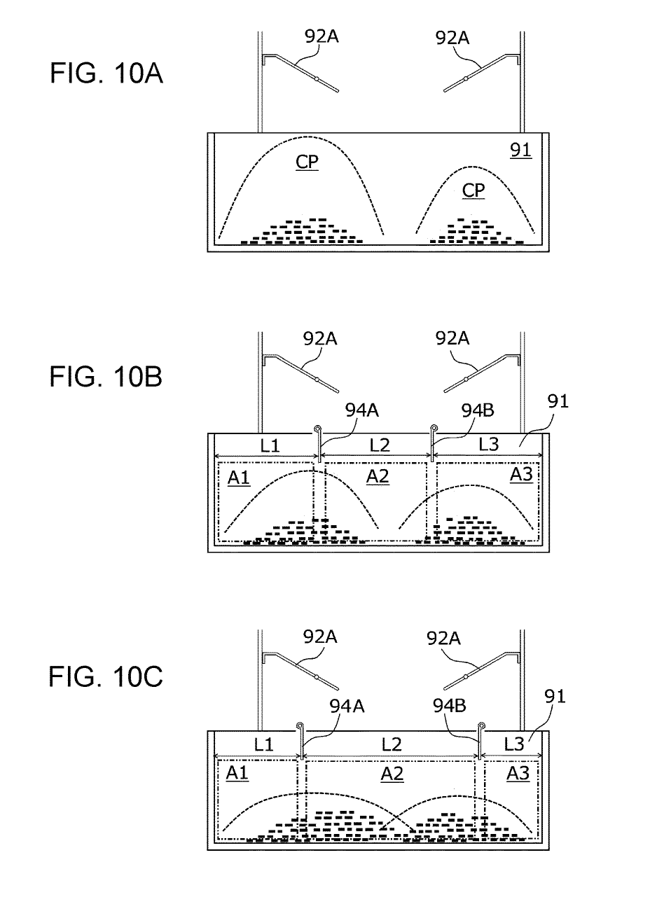

FIGS. 10A to 10C are schematic cross sections each explaining a relationship between arrangement positions of first and second leveling members in a pull-out direction of a sheet-waste housing box and accumulated side edge parts; and

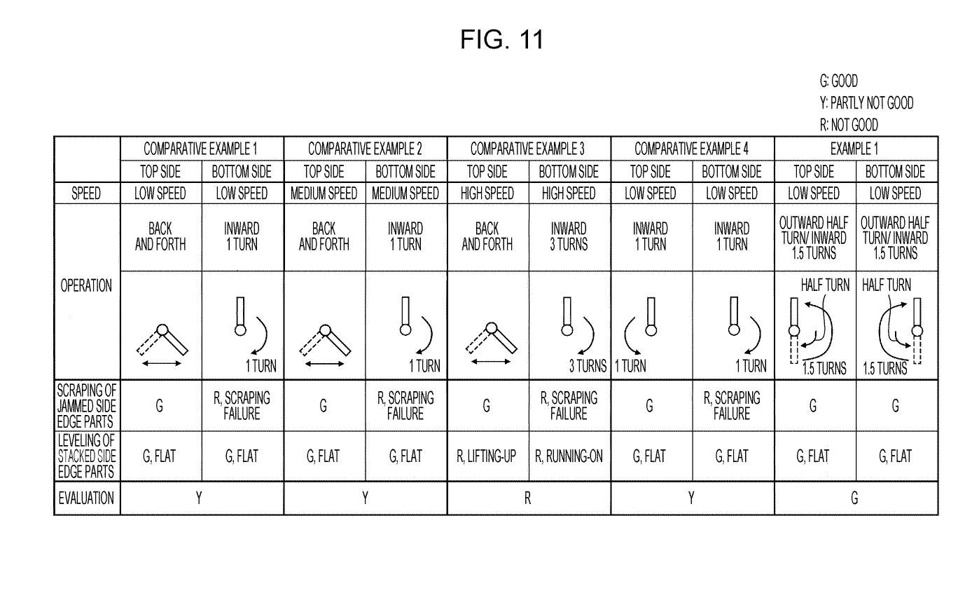

FIG. 11 illustrates an example of results when the first and second leveling members are rotated to level the side edge parts accumulated in the sheet-waste housing box and the leveled states of the side edge parts are evaluated.

### DETAILED DESCRIPTION

The present invention is described in detail below according to exemplary embodiments and specific examples with reference to the drawings. However, the present invention is not limited to these embodiments and specific examples.

Also, in the description with reference to the drawings, it is to be noted that the drawings are schematic drawings and the ratio of respective dimensions etc. is different from the actual value. For easier understanding, illustration of members other than the members required for explanation is omitted as appropriate.

### (1) General Configuration and Operation of Image Forming System

FIG. 1 is a schematic sectional view showing an inside configuration of an image forming system 1 to which this exemplary embodiment is applied. The image forming system 1 shown in FIG. 1, includes an image forming apparatus 100, such as a printer or a copier, that forms an image by an electrophotographic system, a transport apparatus 200 that guides a sheet P with an image recorded to a post-processing apparatus 300, and the post-processing apparatus 300 that provides post-processing on the sheet P with a toner image formed by the image forming apparatus 100.

A general configuration and an operation of the image forming system 1 are described below with reference to the drawings.

### (1.1) General Configuration and Operation of Image Forming Apparatus

The image forming apparatus 100 includes a control device 10, a sheet feed device , photoconductor units 30, developing devices 40, a transfer device 50, a fixing device 50, and an exposure device LS.

The control device 10 includes an image forming apparatus controller 11 that controls an operation of the image forming apparatus 100, a controller 12 that prepares image data in accordance with a print processing request, an exposure controller 13 that controls lighting of the exposure device LS, and a power supply device 14. The power supply device 14 supplies predetermined electric power to the photoconductor units 30, the developing devices 40, the transfer device 50, the fixing device 60, and the exposure device LS.

The sheet feed device 20 in which sheets P as recording media are stacked is provided in a bottom portion of the image forming apparatus 100. The position in the width direction of the sheets P is determined by a regulation plate (not shown). The sheets P are drawn one by one from the top to the front, and then the drawn sheet P is transported to a nip part of a registration roller pair 23.

The photoconductor units 30 are arranged above the sheet feed device 20 in parallel and respectively include photoconductor drums 31 that are rotationally driven. The developing devices 40 form toner images of yellow (Y), magenta (M), cyan (C), and black (K) respectively on the photoconductor drums 31.

The toner images of the respective colors formed on the photoconductor drum 31 of the photoconductor units 30 are sequentially electrostatically transferred (first transfer) on an intermediate transfer belt 51 of the transfer device 50, and thereby superimposed toner images in which the toners of the respective colors are superimposed are formed. The superimposed toner images on the intermediate transfer belt 51 are collectively transferred by a second transfer roller 52, on the sheet P sent out from the registration roller pair 23 and guided by a transport guide.

The sheet P with the toner images collectively transferred in the transfer device 50 is transported to the fixing device 60 in a state in which the toner images are not fixed. The toner images are fixed by an action of pressure and heat by a pair of a heat module 61 and a pressure module 62.

The sheet P with the fixed toner images formed is guided by a transport guide (not shown), and is transported through the transport apparatus 200 to the post-processing apparatus 300.

### (1.2) General Configuration and Operation of Post-Processing Apparatus

The post-processing apparatus 300 includes a crease forming section 307 that forms creases on the sheet P received from the transport apparatus 200, a side edge part removing section (top and bottom trimmer) 308 that removes side edge parts CP of the sheet P, and a sheet-waste housing section 309 that houses the removed side edge parts CP of the sheet P as waste.

Further, the post-processing apparatus 300 includes a post-processing controller 310 that includes a central processing unit (CPU) and a read-only memory (ROM) and that controls respective functional sections of the post-processing apparatus 300. The post-processing apparatus 300 also includes a user interface (UI) 320 that receives an operation input from a user and relating to the post-processing.

In the image forming system 1, a finisher device may be connected subsequently to the post-processing apparatus 300 for sheets P output from the post-processing apparatus 300. The finisher device includes, for example, a compile tray that aligns and compiles the sheets P, an end binding mechanism (stapler) that binds end portions of the sheets P, and a center folding and binding processing mechanism that provides center folding and binding processing to make a booklet.

With such a system configuration, the image forming system may continuously execute, for example, a series of works (print units) for creating a booklet.

### (2) Transport Apparatus

FIG. 2 is a schematic sectional view of the post-processing apparatus 300. FIG. 3A illustrates a structure of a cutter unit 80 included in the side edge part removing section 308, and FIG. 3B illustrates a side edge part CP of a sheet P. FIG. 4A is a schematic longitudinal section of the sheet-waste housing section 309, and FIG. 4B is a schematic cross section of the sheet-waste housing section 309.

A configuration and an operation of the post-processing apparatus 300 are described below with reference to the drawings.

### (2.1) General Configuration

As shown in FIG. 2, the post-processing apparatus 300 has a reception port 301 for receiving the sheet P transported from the image forming apparatus 100 and an output port 302 for outputting the sheet P.

Also, the post-processing apparatus 300 includes a skew detector 303 that detects skew of the received sheet P with respect to a transport direction of the sheet P, a first tilt corrector 304 having swing rollers 72 that correct skew, a second tilt corrector 305 that corrects skew by bringing the leading end of the sheet P into contact with skew correction rollers 73, a side c detector 306 that detects the positions of both ends of the sheet P, the crease forming section 307 that forms creases on the sheet P, the side edge part removing section (top and bottom trimmer) 308 that removes side edge parts CP of the sheet P, and the sheet-waste housing section 309 being an example of a side edge part housing section that houses the removed side edge parts CP of the sheet P as sheet waste.

### (2.2) Sheet Transport Path

The post-processing apparatus 300 has a first sheet transport path S1 as a transport path of the sheet P. The first sheet transport path S1 extends from the reception port 301 as a start point to the output port 302.

Also, the first sheet transport path S1 is provided to pass through the skew detector 303, the first tilt corrector 304, the second tilt corrector 305, the side detector 306, the crease forming section 307, and the side edge part removing section (top and bottom trimmer) 308.

With the first sheet transport path S1, the sheet P received at the reception port 301 is transported to the skew detector 303, the first tilt corrector 304, the second tilt corrector 305, the side detector 306, the crease forming section 307, and the side edge part removing section 308.

The first sheet transport path S1 branches into a first branch path S11 and a second branch path S12 at a position located downstream of the side edge part removing section 308 (see P2 in FIG. 2). The first branch path S11 and the second branch path S12 join into one at a position located upstream of the output port 302 (see P3 in FIG. 2).

Further, the post-processing apparatus 300 has a second sheet transport path S2 branching from the first sheet transport path S1.

The second sheet transport path S2 branches from the first sheet transport path S1 at a position located downstream of the first tilt corrector 304 and upstream of the crease forming section 307 (see P1 in FIG. 2). The second sheet transport path S2 extends from a position at which the second sheet transport path S2 connected with the first sheet transport path S1 as a start point to the output port 302.

A sheet P the creases of which are not formed by the crease forming section 307 and the side edge parts of which are not removed by the side edge part removing section 308 is transported through the second sheet transport path S2 to the output port 302.

The branch point (P1) at which the second sheet transport path S2 branches from the first sheet transport path S1, the branch point (P2) at which the first sheet transport path S1 branches into the first branch path S1 and the second branch path S12, and the joint point (see P3 in FIG. 2) at which the first branch path S11, the second branch path S12, and the second sheet transport path S2 join into one are provided with gates (not shown) for switching the transport path of the sheet P.

Also, plural transport rollers 71 are provided in the first sheet transport path S1 and the second sheet transport path S2. The transport rollers 71 transport the sheet P to the downstream side in the sheet transport direction.

### (2.3) Function and Operation of Post-Processing Apparatus

The skew detector 303 includes two detecting members provided in a direction intersecting with (orthogonal to) the transport direction of the sheet P. Each detecting member includes a light emitting element and a light receiving element. The skew detector 303 calculates skew in the direction intersecting with (orthogonal to) the transport direction of the transported sheet P from a time difference in shielding of light when the sheet P passes through the two detecting members.

The first tilt corrector 304 includes the swing rollers 72. The swing rollers 72 include a driving roller that is rotationally driven by a motor, and a driven roller that is rotated by contacting the driving roller and receiving a driving force from the driving roller.

First ends of shafts of the swing rollers 72 are fixed, and second ends of the shafts are able to be tilted with respect to the direction intersecting with (orthogonal to) the transport direction of the sheet P. The tilt amount of the swing rollers 72 is set in accordance with the skew amount of the sheet P detected by the skew detector 303 immediately before the sheet P arrives.

If the swing rollers 72 pinch the sheet P in a tilted state the state is restored from the tilted state to an original non-tilted state, and the sheet P is transported in a state in which the skew of the sheet P is corrected.

The second tilt corrector 305 corrects the skew of the sheet P corrected by the first tilt corrector 304, with higher accuracy. The second tilt corrector 305 includes the skew correction rollers 73 that correct the skew by bringing the sheet P into contact with the tilt correction rollers 73.

The skew correction rollers 73 are kept in a state in which rotation is stopped immediately before the sheet P contacts the skew correction rollers 73. The sheet P contacts the skew correction rollers 73 and forms a loop. The rotation of the skew correction rollers 73 is resumed at a timing at which the loop is generated, and the skew of the sheet P is corrected.

The side detector 306 detects ends of the sheet P in the direction orthogonal to the transport direction of the sheet P. For example, the positions of the ends of the sheet P are detected by line sensors. In this case, the positions of the ends in the direction orthogonal to the transport direction of the sheet P vary depending on the sheet P.

The crease forming section 307 includes advance members that advance from sides of the first sheet transport path S1 toward the first sheet transport path S1. By pressing the advance members to the sheet P, creases are formed on the sheet P. A device that provides folding processing disposed subsequently to the post-processing apparatus 300 folds the sheet P along the creases.

If the creases are not formed on the sheet P, the sheet P is transported to the side edge part removing section 308 without formation of the creases.

The side edge part removing section 308 is a device that executes trimming. The side edge part removing section 308 removes portions of side edge parts CP (side edge parts along the first sheet transport path S1) of the sheet P. The side edge part removing section 308 includes, for example, the cutter unit (rotary cutter unit) 80 (see FIG. 3A) having a shaft provided in the direction orthogonal to the transport direction of the sheet P and a disk-shaped blade fixed to the shaft.

The cutter unit 80 includes two cutter units 80 provided in the direction intersecting with (orthogonal to) the transport direction of the sheet P, and simultaneously removes side edge parts CP at both end portions of the sheet P.

The width of the sheet P varies depending on the booklet to be made. Hence the two cutter units 80 move along the shafts in accordance with the positions of the sides of the sheet P detected by the side detector 306 and the sizes of the side edge parts CP of the sheet P to be trimmed, and cut off the side edge parts CP of the sheet P.

The sheet-waste housing section 309 houses the side edge parts CP of the sheet P cut off in the side edge part removing section 308, as sheet waste.

If the sheet P is not trimmed, the sheet P is transported to the output port 302 in a state in which the side edge parts CP of the sheet P are not removed.

### (2.4) Side Edge Part Removal of Sheet

As shown in FIG. 3A, each cutter unit 80 includes a cutter portion 311 being an example of a side edge part removing portion, and a line applying portion 312 that gives stiffness to the sheet waste.

The cutter portion 311 includes a rotary cutter 82 being a disk-shaped blade, and a cylindrical pressing member 83 to which the rotary cutter 82 is pressed.

The line applying portion 312 includes a disk 84 and a groove 87 that receives an outer edge of the disk 84.

The rotary cutter 82, the pressing member 83, the disk 84, and the groove 87 are arranged around shafts 81A and 81B provided in parallel to the direction orthogonal to the transport direction of the sheet P.

The rotary cutter 82 and a cylindrical elastic body 85 made of rubber and having the groove 87 are provided around the shaft 81A with a predetermined gap interposed therebetween. The pressing member 83 to which the rotary cutter 82 is pressed, the disk 84 adjacent to the pressing member 83, and a cylindrical elastic body 86 made of rubber and being adjacent to the disk 84 are provided around the shaft 81B.

The disk 84 has a larger outer diameter than the outer shape of the pressing member 83. Hence outer periphery of the disk 84 protrudes to the outside of the pressing member 83. It is to be noted that the outer diameter of the elastic body 86 is set to be equivalent to the outer diameter of the pressing member 83.

The outer periphery of the disk 84 is inserted into the groove 8, provided in the elastic body 85, the elastic body 85 contacts the elastic body 86, and thereby a driving force is transmitted.

With this configuration, when the shaft 81A receives the rotational driving, the elastic body 85 fixed to the shaft 81A is rotated, the driving force is transmitted to the elastic body 86 fixed to the shaft 81B, and the shaft 81B is rotated.

Consequently, the side edge part CP is cut off from the sheet P pinched between the rotary cutter 82 and the pressing member 83. It is to be noted that a pressure is applied to the rotary cutter 82 and the pressing member 83 by a spring (not shown) to mesh with one another.

As shown in FIG. 3B, a line 88 is formed in the transport direction of the sheet P along the side edge part CP of the sheet P. For example, in a case where the width of the side edge part CP of the sheet P is in a range from 6 to 25 mm, to allow the line 88 to be formed even if the width of the side edge part CP of the sheet P is 6 mm which is the narrowest, the line 88 is formed along the long and narrow side edge part CP at a 4-mm position from the rotary cutter 82.

The side edge part CP with the line 88 formed is not easily bent in a direction orthogonal to the line 88 as compared with a case without the line 88. The stiffness in the sheet transport direction of the side edge part CP is increased, the side edge part CP is not easily bent, and the rod shape is easily kept.

Consequently, as shown in FIG. 2, the side edge part OP of the sheet P trimmed by the cutter unit 80 advances in an oblique direction (in the lower right direction in FIG. 2) along the provided guide from the 52 portion, and is housed in the sheet-waste housing section 309.

The sheet P from which the side edge part CP is trimmed is transported along the provided guide from the P2 portion to the first branch path S11 or the second branch path S12.

### (2.5) Sheet-Waste Housing Section

As shown in FIGS. 4A and 4B, the sheet-waste housing section 309 includes a sheet-waste housing box 91 and side edge part guides 92 being an example of a guide plate.

The sheet-waste housing box 91 houses the trimmed side edge parts CP. The sheet-waste housing box 91 is mounted so as to be pulled out to the front surface side (operator side) of the post-processing apparatus 300.

The side edge part guides 92 are plate-shaped members provided obliquely toward the direction of gravitational force. As shown in FIG. 4B, the side edge part guides 92 are arranged to define a truncated V shape or a substantially truncated V shape.

The side edge part guides 92 are respectively provided below the left and right cutter units 80 in correspondence with the cutter units 80.

When the side edge parts CP with the lines 88 formed fall from the cutter units 80, front ends of the side edge parts CP are guided by inclined surfaces 92a of the side edge part guides 92, and move in a sliding manner in the horizontal direction (arrow R1 in FIG. 4A) on the inclined surfaces 92a. Then, rear ends of the side edge parts CP having rod shapes because the lines 88 are formed fall on the inclined surfaces 92a of the side edge part guides 92 (arrow R2 in FIG. 4A). Consequently, the side edge parts CP fall substantially horizontally in the sheet-waste housing box 91 (arrow R1 in FIG. 4A), and are housed in the sheet-waste housing box 91 without forming a hill in the moving direction of the side edge parts CP in the sheet-waste housing box 91. Accordingly, housing efficiency of the sheet-waste housing box 91 may be increased.

### First Modification

FIG. 5 is a perspective sectional view of a sheet-waste housing section 309A according to a first modification. FIG. 6 is a schematic cross section of the sheet-waste housing section 309A according to the first modification. The sheet-waste housing section 309A includes the sheet-waste housing box 91, the side edge part guides 92, and second side edge part guides 93 being an example of a second guide plate.

The second side edge part guides 93 are plate-shaped members obliquely provided toward the direction of gravitational force similarly to the side edge part guides 92. The second side edge part guides 93 are arranged to define an inverted V shape or a substantially inverted V shape, below the left and right side edge part guides 92 arranged in the truncated V shape or the substantially truncated V shape.

As schematically shown in FIG. 6, the side edge parts CP which are guided by the inclined surfaces 92a of the side edge part guides 92 and become substantially horizontal in the moving direction of the side edge parts CP are guided by inclined surfaces 93a of the second side edge part guides 93 arranged below the side edge part guides 92, fall substantially horizontally, and are housed while distributed in the front-rear direction (near side and deep side) in the pull-out direction of the sheet-waste housing box 91. Consequently, the housing efficiency of the sheet-waste housing box 91 may be further increased.

### Second Modification

FIG. 7 is a schematic cross section of a sheet-waste housing section 309B according to a second modification. The sheet-waste housing section 309B includes the sheet-waste housing box 91, side edge part guides 92A, and the second side edge part guides 93.

The side edge part guides 92A each include a fixed guide portion 92Aa and a movable guide portion 92Ab. The movable guide portion 92Ab is able to be bent downward with respect to the fixed guide portion 92Aa (see as row R4 in FIG. 7).

Consequently, the gap between an inclined-surface distal end portion of each side edge part guide 92A and an inclined-surface distal end portion of the corresponding second side edge part guide 93 may be increased and thereby the side edge part CP may reliably fall from the side edge part guide 92A to the second side edge part guide 93.

### Second Exemplary Embodiment

FIG. 8 is a perspective sectional view showing a sheet-waste housing section 409 of a post-processing apparatus 400 according to this exemplary embodiment. FIG. 9 is a schematic cross section of the sheet-waste housing section 409. FIGS. 10A to 10C are schematic cross sections each explaining a relationship between arrangement positions of first and second leveling members 94A and 94B in the pull-out direction of the sheet-waste housing box 91, and trimmed and accumulated side edge parts CP. FIG. 11 illustrates an example of results when the first and second leveling members 94A and 94B are rotated to level the side edge parts CP accumulated in the sheet-waste housing box 91 and the leveled states of the side edge parts CP are evaluated.

A configuration and an operation of the sheet-waste housing section 409 in the post-processing apparatus 400 are described below with reference to the drawings. The same reference sign is applied to a component common to the post-processing apparatus 300 according to the first exemplary embodiment, and the redundant detailed description is omitted.

### (1) Configuration of Sheet Housing Section

### (1.1) General Configuration of Sheet Housing Section

The sheet-waste housing section 409 includes the sheet-waste housing box 91, the side edge part guides 92A, the second side edge part guides 93, and a leveling member 94.

Each side edge part guide 92A includes the fixed guide portion 92Aa and the movable guide portion 92Ab. The movable guide portion 92Ab is able to be bent downward with respect to fixed guide portion 92Aa (see arrow R4 in FIG. 7).

The second side edge part guides 93 are plate-shaped members obliquely provided toward the direction of gravitational force. The second side edge part guides 93 are respectively arranged to define the inverted V shape or substantially inverted V shape, below the side edge part guides 92A arranged in the truncated V shape or the substantially truncated V shape.

The leveling member 94 includes a rotation shaft 94a and a plate-shaped leveling portion 94b attached to the rotation shaft 94a to protrude in a radial direction of the rotation shaft 94a. The leveling member 94 includes the first leveling member 94A and the second leveling member 94B arranged below the left and right side edge part guides 92A. The first leveling member 94A is disposed on the near side in the pull-out direction of the sheet-waste housing box 91 (referred to as top side). The second leveling member 94B is disposed on the deep side in the pull-out direction of the sheet-waste housing box 91 (referred to as bottom side).

The leveling member 94 rotates forward and backward when the rotation shaft 94a receives rotational driving from a motor M being a driving source.

Consequently, the plate-shaped leveling portions 94b of the first leveling member 94A and the second leveling member 94B may rotate in a direction to approach one another and in a direction to separate from one another.

### (1.2) Arrangement of Leveling Members

As shown in FIG. 9, the first leveling member 94A is disposed at a position at a distance L1 from an end portion on the top side of the sheet-waste housing box 91, and the second leveling member 94B is disposed at a position at a distance L2 from an end portion on the bottom side of the sheet-waste housing box 91.

Also, the first leveling member 94A and the second leveling member 94B are arranged to separate from one another in the pull-out direction of the sheet-waste housing box 91 by a distance L3.

The distances L1, L2, and L3 are relative distances that satisfy 2×L1<L3 and 2×L2≦L3.

As shown in FIG. 10A, if the width of a left trimmed side edge part CP differs from the width of a right trimmed side edge part CP in the direction intersecting with the transport direction of the sheet P, the accumulated height of the side edge parts CP is not uniform between the top side and the bottom side of the sheet-waste housing box 91 (see broken lines in FIG. 10A), and the housing efficiency of the sheet-waste housing box 91 may be decreased.

As shown in FIG. 10B, if the first leveling member 94A and the second leveling member 94B are arranged uniformly in the pull-out direction (L1=L2=L3), an area A1 on the top side of the sheet-waste housing box 91, an area A3 on the bottom side of the sheet-waste housing box 91, and a common area A2 between the top side and the bottom side are substantially uniformly arranged.

Consequently, even if the side edge parts CP accumulated on the top side and the side edge parts CP accumulated on the bottom side are leveled by the first leveling member 94A and the second leveling member 94B, the accumulated side edge parts CP are not efficiently moved to the common area A2, and the housing efficiency of the sheet-waste housing box 91 is not sufficiently increased.

As shown in FIG. 10C, if the first leveling member 94A and the second leveling member 94B are arranged at relative distances that satisfy 2×L1≦L3 and 2×L2≦L3, the common area A2 is expanded.

Consequently, the side edge parts CP accumulated by a large height on the top side is moved by the first leveling member 94A to the expanded common area A2, and the accumulated side edge parts CP on the top side are leveled. Accordingly, the housing efficiency of the sheet-waste housing box 91 may be increased.

### (2) Operations of Leveling Members

The first leveling member 94A.and the second leveling member 94B rotate in the direction intersecting with the moving direction of the trimmed side edge parts CP, contact the side edge parts CP accumulated on the top side and the bottom side of the sheet-waste housing box 91, and level the side edge parts CP while moving the side edge parts CP to the common area A2. Accordingly, the housing efficiency of the sheet-waste housing box 91 may be increased.

To be specific, the first leveling member 94A and the second leveling member 94B are rotated so that the number of times the first and second leveling members 94A and 94B rotate in the direction to approach one another is larger than the number of times the first and second leveling members 94A and 94B rotate in the direction to separate from one another. Accordingly, the side edge parts CP accumulated on the top side and the bottom side of the sheet-waste housing box 91 may be substantially uniformly leveled.

### EXAMPLES

FIG. 11 illustrates examples of results when the first and second leveling members 94A and 94B are rotated to level the side edge parts CP accumulated in the sheet-waste housing box 91 and the leveled states of the side edge parts CP are evaluated.

In the evaluation, the rotation directions (inward, outward, or back and forth), the numbers of rotations (half turn, one turn, or three turns), and the rotation speeds (low speed, medium speed, or high speed) of the first leveling member 94A (top side) and the second leveling member 94B (bottom side) are changed, and the states of scraping the side edge parts CP stacked in a hill shape and jammed in the sheet-waste housing box 91 and the states of leveling the side edge parts CP accumulated in the sheet-waste housing box 91 are visually checked.

In Comparative Example 1, the first leveling member 94A (top side) and the second leveling member 94B (bottom side) are rotated at low speed, the first leveling member 94A (top side) is rotated back and forth, and the second leveling member 94B (bottom side) is rotated inward by one turn. Consequently, the leveled states of the accumulated side edge parts CP are good (G); however, a scraping failure (R) of the side edge parts CP, which are stacked in a hill shape and jammed, by the second leveling member 94B (bottom side) occurs, and the evaluation is partly not good (Y).

In Comparative Example 2, the speed of rotation of the first leveling member 94A (top side) and the second leveling member 94B (bottom side) is increased to medium speed from the state in Comparative Example 1; however, the result is similar to Comparative Example 1.

In Comparative Example 3, the first leveling member 94A (top side) and the second leveling member 94B (bottom side) are rotated at high speed, the first leveling member 94A (top side) is rotated back and forth, and the second leveling member 94B (bottom side) is rotated inward by three turns. Consequently, the leveled states of the accumulated side edge parts CP are not good (R: lifting-up or running-on), a scraping failure (R) of the side edge parts CP, which are stacked in a hill shape and jammed, by the second leveling member 94B (bottom side) occurs, and the evaluation is not good (R).

In Comparative Example 4, the first leveling member 94A (top side) and the second leveling member 94B (bottom side) are rotated at low speed, and the first leveling member 94A (top side) and the second leveling member 94B (bottom side) are rotated inward by one turn. Consequently, the leveled states of the accumulated side edge parts CP are good (G); however, a scraping failure (R) of the side edge parts CP, which are stacked in a hill shape and jammed, by the second leveling member 94B (bottom side) occurs, and the evaluation is partly not good (Y).

In Example 1, the first leveling member 94A (top side) and the second leveling member 94B (bottom side) are rotated at low speed, and the first leveling member 94A (top side) and the second leveling member 94B (bottom side) are rotated in the direction to separate from one another by half turn (outward half turn) and then are rotated in the direction to approach one another by 1.5 turns (inward 1.5 turns). Consequently, the leveled states of the accumulated side edge parts CP are good (G), the side edge parts CP, which are stacked in a hill shape and jammed, are scraped, and the evaluation is good (G).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A post-processing apparatus comprising:
a side edge part removing portion that removes a side edge part from a sheet;
a side edge part housing section that houses the side edge part removed by the side edge part removing portion and that is able to be pulled out from an apparatus body; and
a guide plate that is inclined in a direction intersecting with a moving direction of the side edge part and guides the side edge part removed by the side edge part removing portion along the moving direction of the side edge part to the side edge part housing section.

2. The post-processing apparatus according to claim 1,
wherein the guide plate includes inclined surfaces defining a substantially valley shape having a center portion and both end portions along the moving direction of the side edge part, the both end portions being higher than the center portion.

3. The post-processing apparatus according to claim 1, further comprising:
a second guide plate arranged below the guide plate and including inclined surfaces defining a substantially mountain shape having a center portion and both end portions along the moving direction of the side edge part, the both end portions being lower than the center portion.

4. The post-processing apparatus according to claim 3,
wherein a portion on a distal end side of each of the inclined surfaces of the guide plate is bent downward along the moving direction of the side edge part to increase a gap between the guide plate and the second guide plate along the moving direction of the side edge part.

5. The post-processing apparatus according to claim 1, further comprising:
a leveling member that is provided below the guide plate and levels a height of the side edge part stacked in the side edge part housing section.

6. The post-processing apparatus according to claim 5,
wherein the leveling member includes a first leveling member disposed at a position at a distance L1 from an end portion on a near side in a pull-out direction of the side edge part housing section and a second leveling member disposed at a position at a distance L2 from an end portion on a deep side in the pull-out direction of the side edge part housing section, and the distance L1 and the distance L2 satisfy conditions as follows for a distance L3 between the first level member and the second leveling member,
2×L1<L3, and
2×L2≦L3.

7. The post processing apparatus according to claim 5,
wherein the leveling member rotates forward and backward in the direction intersecting with the moving direction of the side edge part, and a number of rotations of the first and second leveling members in a direction to approach one another is larger than a number of rotations of the first and second leveling members in a direction to separate from one another.

8. An image forming system comprising:
an image forming apparatus that forms an image on a sheet; and
the post-processing apparatus according to claim 1.
